(19) United States
(12) Patent Application Publication
(10) Pub. No.: US 2014/0358659 A1
(43) Pub. Date: Dec. 4, 2014

(54) ELECTRONIC COMMERCE APPARATUS, PRIVILEGE CONTROL METHOD, PRIVILEGE CONTROL PROGRAM, AND COMPUTER READABLE STORAGE MEDIUM FOR STORING PROGRAM

(71) Applicant: Soh Masuko, Shinagawa-ku (JP)

(72) Inventor: Soh Masuko, Shinagawa-ku (JP)

(73) Assignee: RAKUTEN, INC., Shinagawa-ku, Tokyo (JP)

(21) Appl. No.: 14/344,102

(22) PCT Filed: Mar. 28, 2012
(86) PCT No.: PCT/JP2012/058237

§ 371 Date: Mar. 11, 2014

(30) Foreign Application Priority Data
Sep. 13, 2011 (JP) 2011-199841

(51) Int. Cl. G06Q 30/02; G06Q 30/06

(52) U.S. Cl. CPC G06Q 30/0222; G06Q 30/0601
USPC 705/14.23; 705/26.1

(57) ABSTRACT

An electronic commerce apparatus has: a determination unit that determines a product page on which an object is displayed based on an access state; a control unit that controls the display or non-display of the object on the product page; and a transmission unit that transmits a privilege presentation page to a user terminal according to operation information on the object. With this configuration, the access state is reflected on the determination of a product page to be a target of granting privilege, hence the granting of privilege can function as an incentive to purchase a product. Further, the display or non-display of an object is controlled according to the access state, so a user who desires privilege can search for a product page on which the object is displayed.

### TECHNICAL FIELD

The present invention relates to an electronic commerce apparatus, a privilege control method, a privilege control program, and a computer readable storage medium for storing the program.

### BACKGROUND ART

In a conventional electronic commerce site, a service to grant points to a user in response to the purchase of a product has been provided, and in such a service, a privilege to be granted more points than usual for each product or each store is provided at times. Further, in a service to grant points, a service, which provides a status to receive privilege to be granted more points than a case of ordinary purchasing of products by registering in a predetermined campaign, is offered. If the user purchases a product when this status is offered, the user can acquire points according to the content of the privilege. Patent Literature 1 below discloses a system for managing a service to grand predetermined campaign points to a user who registered in a campaign.

### CITATION LIST

### Patent Literature

Patent Literature 1: Japanese Patent Application

### SUMMARY OF INVENTION

### Technical Problem

In a conventional electronic commerce site, a product and a store subject to granting of a privilege is preset, therefore the privilege of granting points cannot function as an incentive for purchasing a predetermined product or for purchasing a product of a predetermined store according to the access state that change in real time.

With the foregoing in view, it is an object of the present invention to provide an electronic commerce apparatus, a privilege control method, and a privilege control program that allow a privilege to be granted to a user in response to purchase of a product to function as an incentive corresponding to the access state that changes in real time, and a computer readable storage medium for storing the program.

### Solution to Problem

To solve the problem, an electronic commerce apparatus according to an aspect of the present invention is an electronic commerce apparatus that has product pages to present sales target products to user terminals in correspondence with respective products, and transmits the product pages to a user terminal in response to a request from the user terminal, comprising: a determination means for referring to an access state storage means that stores an access state information from user terminals to product pages, and determines a product page to display a specific object based on the access state information; a control means for performing display control to display the object on the product page determined by the determination means, and a non-display control to not display the object, at a predetermined timing, on the product page on which the object has been displayed; and a transmission means for transmitting, to the user terminal, a privilege presentation page for presenting privilege information on a privilege provided to the user upon receiving operation information indicating that the user has operated the object displayed on the product page that is displayed on the user terminal.

A privilege control method according to an aspect of the present invention is a privilege control method used for an electronic commerce apparatus that has product pages to present sales target products to user terminals in correspondence with respective products, and transmits the product pages to a user terminal in response to a request from the user terminal, comprising: a determination step of referring to an access state storage means that stores an access state from user terminals to product pages, and determining a product page to display a specific object based on the access state; a display control step of displaying the object on the product page determined in the determination step; a transmission step of transmitting, to the user terminal, a privilege presentation page for presenting privilege information on a privilege provided to the user upon receiving an operation by the user performed on the object displayed on the product page that is displayed on the user terminal; and a non-display control step of performing non-display control to not display the object, at a predetermined timing, on the product page on which the object has been displayed.

A privilege control program according to an aspect of the present invention is a privilege control program for causing a computer to function as an electronic commerce apparatus that has product pages to present sales target products to user terminals in correspondence with respective products, and transmits the product pages to a user terminal in response to a request from the user terminal, the privilege control program causing the computer to execute: a determination function for referring to an access state storage means that stores an access state from user terminals to product pages, and determining a product page to display a specific object based on the access state; a control function to enable display control to display the object on the product page determined by the determination function, and non-display control to not display the object, at a predetermined timing, on the product page on which the object has been displayed; and a transmission function for transmitting, to the user terminal, a privilege presentation page for presenting privilege information on a privilege provided to the user upon receiving an operation by the user performed on the object displayed on the product page that is displayed on the user terminal.

A computer readable storage medium according to an aspect of the present invention is a computer readable storage medium storing a privilege control program for causing a computer to function as an electronic commerce apparatus that has product pages to present sales target products to user terminals in correspondence with respective products, and transmits the product page to a user terminal in response to a request from the user terminal, wherein a commerce management program causes the computer to execute: a determination function for referring to an access state storage means that stores an access state from user terminals to product pages, and determining a product page to display a specific object based on the access state; a control function to enable display control to display the object on the product page determined by the determination function, and non-display control to not display the object, at a predetermined timing, on the product page on which the object has been displayed; and a transmission function for transmitting, to the user terminal, a privilege presentation page for presenting privilege information on a privilege provided to the user upon receiving an operation by the user performed on the object displayed on the product page that is displayed on the user terminal.

According to this aspect, a product page on which an object to receive privilege is determined based on the access state, and display or non-display of the object on the product page are controlled, therefore the access state is reflected in determination of a product page to grant privilege. Hence granting of a privilege can function as an incentive to purchase a product according to the access state.

In the electronic commerce apparatus according to another aspect, the control means may perform the non-display control for the object on one product page first, and then perform the display control to display the object on a product page that is determined by the determination means and is different from that one product page.

According to this aspect, when an object displayed on one product page is no longer displayed at a predetermined timing, an object is displayed on another product page. This encourages a user who desires provision of a privilege to browse a plurality of product pages on a site by searching for a product page on which an object is displayed.

In the electronic commerce apparatus according to another aspect, the privilege presentation page may include an operation means for transmitting post information that instructs to display information on a product page on which an object is displayed, on a page viewable from general user terminals, and if the operation unit is operated by the user terminal where the privilege presentation page is presented, the post information may be transmitted from the user terminal to a predetermined transmission destination.

According to this aspect, information on the product page on which the object is displayed is known to general users, so these users can be guided to the sites managed by the electronic commerce apparatus.

In the electronic commerce apparatus according to another aspect, the predetermined transmission destination may be at least one of the electronic commerce apparatus, a predetermined social network service, and a web site that provides a web page to open the received information to general users on the Internet.

According to this aspect, information on the product page on which the object is displayed can be opened to various transmission destinations mentioned above.

The electronic commerce apparatus according to another aspect may further comprise a privilege information management means for receiving the post information, generates or updates an information providing page which includes information on a product page on which an object is displayed, and replies with the information providing page in response to a request from a general user terminal.

According to this aspect, the information on the product page on which the object is displayed can be opened to the public on a dedicated page provided by the electronic commerce site. Furthermore, the information on the product page on which the object is displayed is integrated to the information providing page, so general users can easily access the information.

In the electronic commerce apparatus according to another aspect, the determination means may acquire, as the access state, the number of accesses of each product page that has been accessed by user terminals in a predetermined time period, and determines displaying the specific object on at least one of the product pages of which the number of accesses is a predetermined number or more, or less than a predetermined number.

According to this aspect, if a product page of which the number of accesses is a predetermined number or more is determined as a product page on which an object is displayed, the object can be displayed on a product page which has high probability to be viewed by many users. If a product page, of which the number of accesses is less than a predetermined number, is determined as a product page on which an object is displayed, users can be guided to view the product page by the display of the object.

In the electronic commerce apparatus according to another aspect, the determination means may acquire, for each product page, the number of users who have viewed the product page by now as the access state, and determines displaying the specific object on the product page of which the number of users is a predetermined number or more, or less than a predetermined number. Here the number of users refers to the number of user terminals or the number of users who logged in.

According to this aspect, if a product page, of which a predetermined number of users or more have viewed the product page by now, is determined as a product page on which an object is displayed, the object can be presented to many users. If a product page, of which less than a predetermined number of users have viewed the product page by now, is determined as a product page on which an object is displayed, the number of users to whom the privilege is provided based on the presentation of the privilege information can be controlled to be non-excessive.

In the electronic commerce apparatus according to another aspect, the determination means may acquire, for each product page, the number of user terminals which have viewed the product page by now and have a predetermined attribute. Here “by now” refers to a time zone from a predetermined time in the past until the present.

According to this aspect, the object can be presented to many users having a specific attribute, hence it can be controlled so that the privilege is provided to the user having the specific attribute with priority, for example.

In the electronic commerce apparatus according to another aspect, the access state to a product page may include at least one of the number of sales of the product presented on the product page and a total sales amount thereof, and the determination means may determine displaying the specific object on a product page of a product of which the number of sales or the sales amount in a predetermined time period is a predetermined value or more, or less than a predetermined value.

According to this aspect, if a product page of a product, of which number of sales or sales amount in a predetermined time period is a predetermined value or more, is determined as a product page on which the object is displayed, the object can be displayed on a product page which has high probability to be purchased by many users. If a product page of a product, of which the number of sales or sales amount in a predetermined time period is less than a predetermined value, is determined as a product page on which the object is displayed, users can be guided to purchase the product by the display of the object.

In the electronic commerce apparatus according to another aspect, the access state to a product page may include at least one of the number of sales of the product and a total sales amount thereof, and the determination means may determine displaying the specific object on a product page of a product of which a ratio of the number of sales or the sales amount to the number of accesses from the user terminals to the product page in a predetermined time period is a predetermined value or more, or less than a predetermined value.

According to this aspect, if a product page, of which ratio of the number of sales or sales amount to the number of accesses from the user terminals to the product page is a predetermined value or more, is determined as a product page on which the object is displayed, the object can be displayed on a product page which has high probability for the product to be purchased. If a product page, of which ratio of the number of sales or sales amount to the number of accesses from the user terminals to the product page is less than a predetermined value, is determined as a product page on which the object is displayed, a ratio of the number of users who purchase this product with respect to the number of users who accessed this product page can be improved by the display of the object.

In the electronic commerce apparatus according to another aspect, points may be granted to a user by purchase of a product via electronic commerce provided by the electronic commerce apparatus, and the privilege provided to the user for whom the privilege information is presented may be granting of more points than points granted by ordinary purchase of a product, and the determination means may determine, according to the access state and the content of the privilege, a product page on which the specific object is displayed based on an expected value of the points granted to the user by the privilege.

According to this aspect, a product page is selected based on an expected value of points granted to a user by a privilege, so points to be granted to a user as a privilege can be considered when a product page is selected.

In the electronic commerce apparatus according to another aspect, the determination means may determine, a product page on which the specific object is displayed, and where an expected value of points granted to the user by the privilege is not more than a first predetermined value which is set in advance, and an error of the expected value from the first predetermined value is a second predetermined value or less.

According to this aspect, a product page, where an expected value of points granted to the user by privilege is a predetermined value or less or a value close to the predetermined value, is selected, hence the total number of points granted to the user as privilege can be accurately controlled.

In the electronic commerce apparatus according to another aspect, the control means may perform the non-display control when a predetermined time elapses after performing the display control.

According to this aspect, the time which the object is displayed can be controlled to be a predetermined time.

In the electronic commerce apparatus according to another aspect, the control means may acquire the number of accesses from user terminals to the product page on which the object is displayed since the start of the display control, and performs the non-display control when the number of accesses reaches a predetermined number or more.

According to this aspect, the number of users who viewed a product page including an object can be limited to a predetermined number, hence a total number of users to which privilege is provided can be controlled with a predetermined or higher accuracy.

In the electronic commerce apparatus according to another aspect, the control means may perform the non-display control when the number of the operations performed by the user on the object on the user terminal, received by the transmission means, reaches a predetermined number or more.

According to this aspect, a total number of users to which privilege information is presented can be limited to a predetermined number, hence a total of points granted to users, based on the provision of the privilege, can be controlled not to exceed a predetermined number.

In the electronic commerce apparatus according to another aspect, the control means may perform the non-display control when the number of users to whom privilege is provided according to the presentation of the privilege information by the transmission means reaches a predetermined number or more.

According to this aspect, the number of users to which privilege is provided can be limited to a predetermined number, hence a total number of points granted to users based on the provision of the privilege can be controlled with higher accuracy.

In the electronic commerce apparatus according to another aspect, points may be granted to a user by purchase of a product via electronic commerce provided by the electronic commerce apparatus, and the privilege provided to the user for whom the privilege information is presented may be granting of more points than points granted by ordinary purchase of a product, and the control means may perform the non-display control when the total points granted to the user by the privilege reaches a predetermined value, which is set in advance.

According to this aspect, an object is not displayed when the number of points granted by privilege reaches a predetermined value, hence a total of points granted to users based on the provision of the privilege can be controlled not to exceed an expected number.

In the electronic commerce apparatus according to another aspect, the control means may generate, as the display control, a product page including the object based on the product page determined by the determination means, and generate, as the non-display control, a product page by deleting the object from the product page including the object at a predetermined timing.

According to this aspect, a processing to include an object as a display control is performed, and a processing to delete an object (page generation) as a non-display control is performed only on a product page on which the object is displayed, out of the product pages of the electronic commerce apparatus, therefore the display control and the non-display control can be easily performed with a light load.

In the electronic commerce apparatus according to another aspect, the product page may include control information for performing control to display or not display the object on the product page based on an inquiry to the electronic commerce apparatus and instruction information from the electronic commerce apparatus, and as the display control, the control means may generate instruction information to display the object in response to an inquiry from a user terminal which is displaying the product page determined by the determination means, the inquiry being made using the control information included in the product page, and transmit the instruction information to the user terminal, and as the non-display control, the control means may transmit instruction information not to display the object to the user terminal at the predetermined timing, in response to the inquiry from the user terminal which is displaying the product page including the object, the inquiry being made using the control information included in the product page.

According to this aspect, the display control and the non-display control of an object are performed by transmitting the instruction information in response to the inquiry from the control information to the user terminal, hence display of the object on the product page can be controlled with high accuracy.

In the electronic commerce apparatus according to another aspect, it is preferable that, as the display control, the control means may transmit instruction information to a user terminal which is displaying the product page determined by the determination means, to instruct the user terminal to display the object on the product page, and as the non-display control, the control means may transmit instruction information at the predetermined timing to the user terminal which is displaying the product page including the object, to instruct the user terminal not to display the object.

According to this aspect, the display or non-display of an object is controlled by transmitting the application for displaying or not displaying an object on a product page displayed on the user terminal, or a product page of which an object is included or a product page from which an object is deleted, to the user terminal, hence display of an object on a product page can be controlled with high accuracy. Furthermore, communication for inquiry from the user terminal to the electronic commerce apparatus is not required, so the communication load and processing load are low.

### Advantageous Effects of Invention

According to the present invention, a privilege to be granted to a user in response to a purchase of a product on an electronic commerce site can function as an incentive corresponding to the access state that changes in real time.

### BRIEF DESCRIPTION OF DRAWINGS

FIG. 1 is a diagram depicting a configuration of a system including an electronic commerce apparatus;

FIG. 2 is a block diagram depicting a functional configuration of the electronic commerce apparatus;

FIG. 3 is a diagram depicting a hardware configuration of the electronic commerce apparatus;

FIG. 4 are diagrams depicting an example of a top page which is transmitted to a user terminal before transmitting a product page, and an example of a product page;

FIG. 5 shows an example of a configuration of an access history storage unit and stored data;

FIG. 6 shows an example of a configuration of a purchase history storage unit and stored data;

FIG. 7 shows an example of a configuration of an access state storage unit and stored data;

FIG. 8 shows an example of a configuration of a user information storage unit and stored data;

FIG. 9 shows an example of a configuration of a capital point information storage unit and stored data;

FIG. 10 is a diagram depicting an example of a product page generated by a control unit;

FIG. 11 shows an example of a configuration of an object display record storage unit and stored data;

FIG. 12 shows an example of a configuration of a product stock storage unit and stored data;

FIG. 13 shows an example of a configuration of an object operation information storage unit and stored data;

FIG. 14 shows an example of a configuration of a privilege acquired user storage unit and stored data;

FIG. 15 shows an example of a configuration of a granted point storage unit and stored data;

FIG. 16 is a diagram depicting an example of a privilege presenting page;

FIG. 17 shows an example of a configuration of a privilege magnification setting table and stored data;

FIG. 18 is a diagram depicting an example of the information providing page;

FIG. 19 is a flow chart depicting a processing content of the privilege control method which is executed by the electronic commerce apparatus; and

FIG. 20 is a diagram depicting a configuration of a privilege control program.

### DESCRIPTION OF EMBODIMENTS

Embodiments of the present invention will now be described with reference to the accompanying drawings. In the description of the drawings, identical or equivalent elements are denoted by the same reference numerals, and redundant description will be omitted.

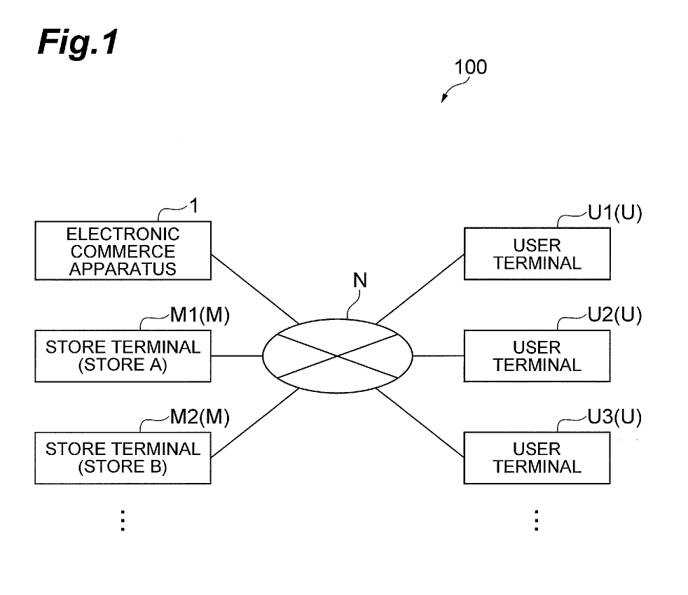

FIG. 1 is a block diagram depicting a configuration of a system 100 including an electronic commerce apparatus according to the present embodiment. The system 100 includes the electronic commerce apparatus 1, a plurality of store terminals M and a plurality of user terminals U. The electronic commerce apparatus 1 of this embodiment is an apparatus that provides a service to accept sales of a product by electronic commerce, and grant points to the user according to the purchase state of the product. Products to be sold are registered by the store terminal M, for example.

The electronic commerce apparatus 1 is also an apparatus that has a product page to present a sales target product to the user terminals U for each product, and transmits the product page to the user terminal U in response to the request from the user terminal U.

When a product is sold, the electronic commerce apparatus 1 of this embodiment can launch a campaign to provide a predetermined privilege to users. This privilege grants more points than those points granted to users by ordinary purchase of a product, and is, for example, points granted by ordinary purchase of a product multiplied by a predetermined number, or a predetermined number of points are granted as bonus points.

In this embodiment, if a specific object included in a product page displayed on a user terminal is selected by operation, privilege information on the privilege is presented to the user. The electronic commerce apparatus 1 determines a product page for displaying the specific object to provide the privilege information, based on various conditions, and performs control so that the object is displayed on the user terminal which received this product page. A specific object refers to an image object, text or the like. The image object can be any image object that can be displayed on the product page. The image object can be, for example, a predetermined graphic, animation character or logo. A plurality of types of specific objects may be used, and one of the plurality of types of objects may be selected and displayed according to the privilege granted to the user. The specific object may or may not exhibit movement.

The electronic commerce apparatus 1, the store terminals M and the user terminals U can communicate with each other via a communication network N, which is the Internet, wireless LAN, mobile communication network or the like. The electronic commerce apparatus 1 is constituted by a server, for example. The store terminal M and the user terminal U are constituted by a portable terminal, a personal computer or the like. In FIG. 1, two store terminals M and three user terminals U are illustrated, but the number of terminals that exist in the system 100 is arbitrary.

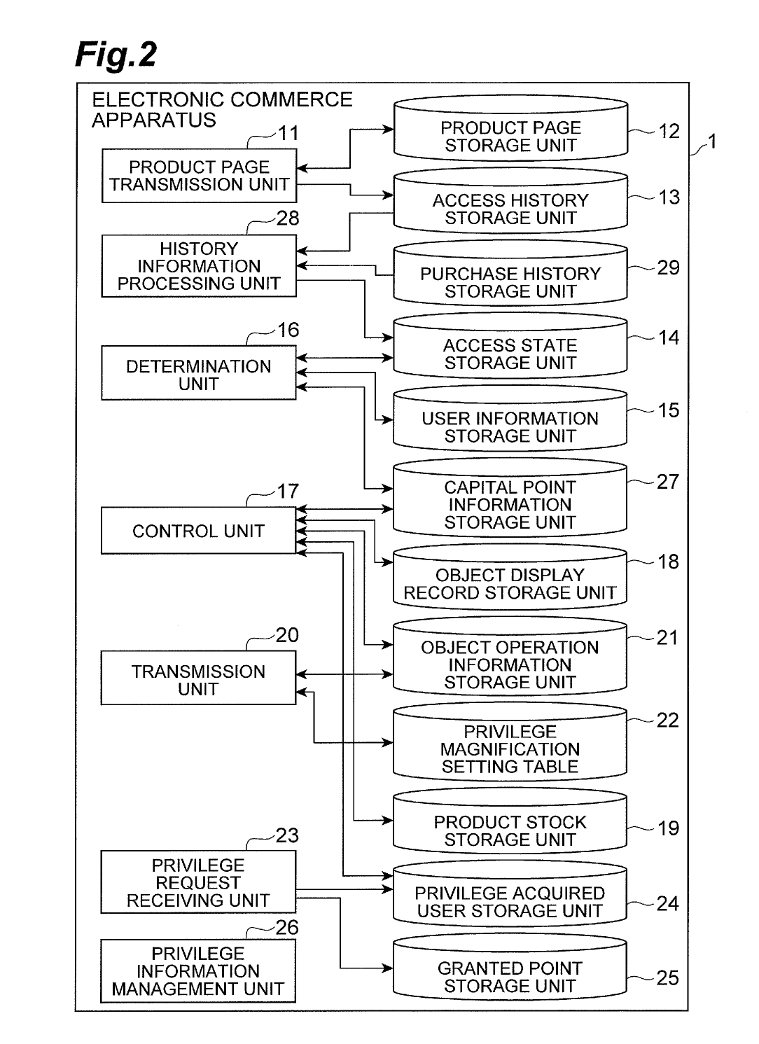

FIG. 2. is a block diagram depicting a functional configuration of the electronic commerce apparatus 1 according to Embodiment 1. As FIG. 2 shows, the electronic commerce apparatus 1 functionally has a product page transmission unit 11, a product page storage unit 12, an access history storage unit 13, an access state storage unit 14 (access state storage means), a user information storage unit 15, a determination unit 16 (determination means), a control unit 17 (control means), an object display record storage unit 18, a product stock storage unit 19, a transmission unit 20 (transmission means), an object operation information storage unit 21, a privilege magnification setting table 22, a privilege request receiving unit 23, a privilege acquired user storage unit 24, a granted point storage unit 25, a privilege information management unit 26 (privilege information management means), a capital point information storage unit 27, a history information processing unit 28, and a purchase history storage unit 29.

In this embodiment, each functional unit 11 to 29 is integrated to one apparatus, but each functional unit 11 to 29 may be provided in a different inter-communicable apparatus respectively. Various storage units and Table 12 to 15, 18, 19, 21, 22, 24, 25, 27 and 29 shown in FIG. 2 are not essential for the configuration of the electronic commerce apparatus 1 of this embodiment. What is required for the electronic commerce apparatus 1 is that each functional unit 11, 16, 17, 20, 23, 26 and 28, to be described later, includes only a storage unit and a table which are referred to when necessary in the respective processing.

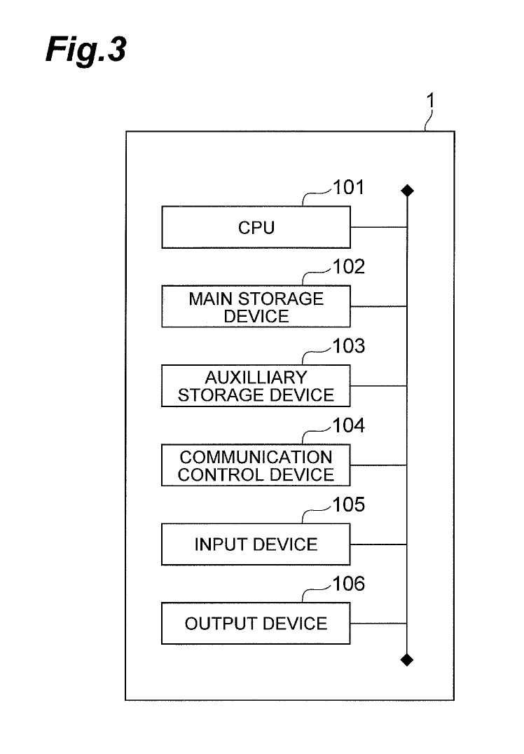

FIG. 3 is a diagram depicting a hardware configuration of the electronic commerce apparatus 1. As FIG. 3 shows, the electronic commerce apparatus 1 is physically configured as a computer system, including a CPU 101, a main storage device 102 constituted by such memory as RAM and ROM, an auxiliary storage device 103 constituted by a hard disk or the like, a communication control device 104 constituted by a network card or the like, an input device 105 such as a keyboard and mouse, and an output device 106 such as a display.

Each function shown in FIG. 2 is implemented by such hardware as the CPU 101 and the main storage device 102 that reads predetermines computer software (privilege control programs) so that the communication control device 104, the input device 105 and the output device 106 operate under control of the CPU 101, and data is read from or written to the main storage device 102 and the auxiliary storage device 103. Data and the data base required for processing are stored in the main storage device 102 and the auxiliary storage device 103. Each functional unit will be described hereinbelow.

The product page transmission unit 11 is a portion to transmit, in response to a request from a user terminal U, a product page to the user terminal. The request from the user terminal U can include a URL to identify a product page, and a product ID to identify a product to be presented by the product page.

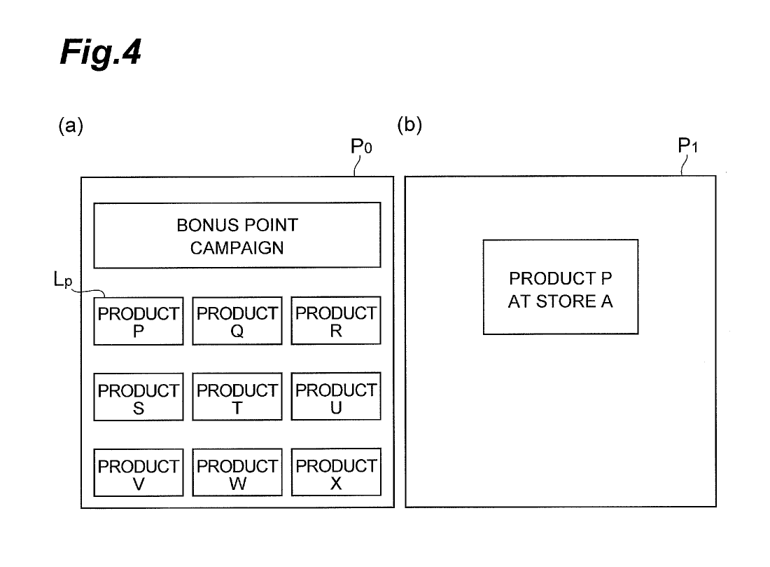

The product page storage unit 12 is a portion that stores product pages. An example of a product page and a product page transmission processing will be described with reference to FIG. 4. FIG. 4(a) is a diagram depicting an example of a top page that is transmitted to the user terminal U prior to transmission of the product page. The top page P₀ includes, for example, a list of products for which privilege may be provided, as shown in FIG. 4(a). The list of the products constitutes a link to the product page of each product.

First the product page transmission unit 11 transmits the top page P₀, as illustrated in FIG. 4(a), to the user terminal U. The user terminal U presents the transmitted top page P₀ to the user, and receives the product selection operation inputted by the user. If one product is selected from the user terminal U, a transmission request for the product page of the product is sent to the electronic commerce apparatus 1.

For example, if a link L_{P} that indicates a product P in FIG. 4(a) is selected, the user terminal U sends the request to transmit the product page of the product P to the electronic commerce apparatus 1. If the request to transmit the product page is received, the product page transmission unit 11 of the electronic commerce apparatus 1 refers to the product page storage unit 12, extracts the product page P₁ of the product P, and replies with the extracted product page P₁ to the user terminal U. FIG. 4(b) is a diagram depicting an example of the product page P₁ of the product P. As FIG. 4(b) shows, the product page P₁ includes information to present the product P. The information to present the product P can include, for example, a store A which presented the product P, an image of the product P and price, for example.

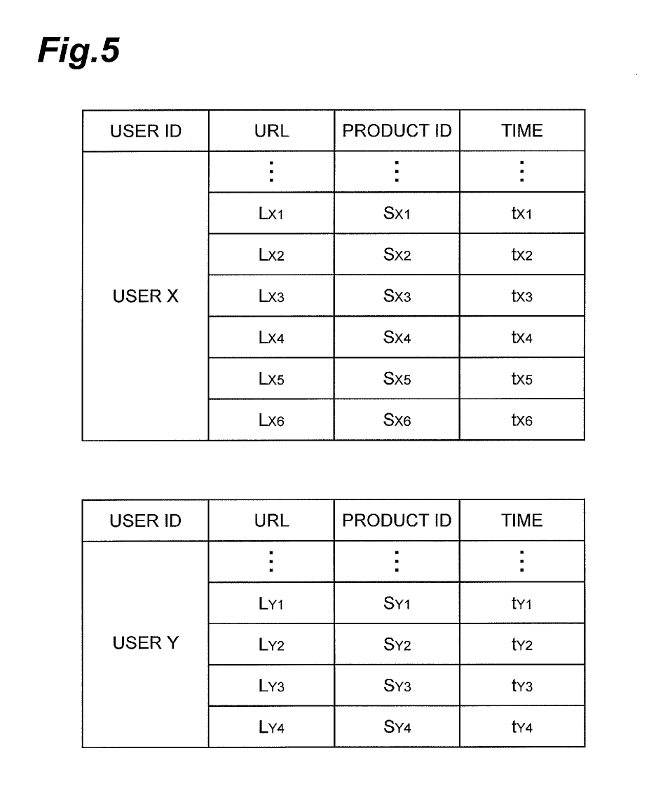

The product page transmission unit 11 stores the history of access the user terminal U performed to each product page in the access history storage unit 13. FIG. 5 shows a configuration of the access history storage unit 13 and stored data. As FIG. 5 shows, the access history storage unit 13 stores the URL of the accessed product page, product ID and time for each user ID for identifying the user of the user terminal U. Only one of URL and product ID may be stored. The access history storage unit 13 stores the access history every time access is performed. Therefore the most recent access of user X to the product page is identified by URL “Lₓ₆” and the product ID “Sₓ₆” performed at time “tₓ₆”. In other words, user X is viewing the product page of product ID “Sₓ₆” at the moment.

The access state storage unit 14 is a portion that stores the access state of each product page, and stores at least the number of accesses and the number of sales for each product ID. The number of accesses is the total number of accesses to the product page of the product in a predetermined period in the past. “the number of sales” is the number of products sold in a same time period. The data stored in the access state storage unit 14 is generated by the history information processing unit 28 based on the data stored the access history storage unit 13 and in the purchase history storage unit 29.

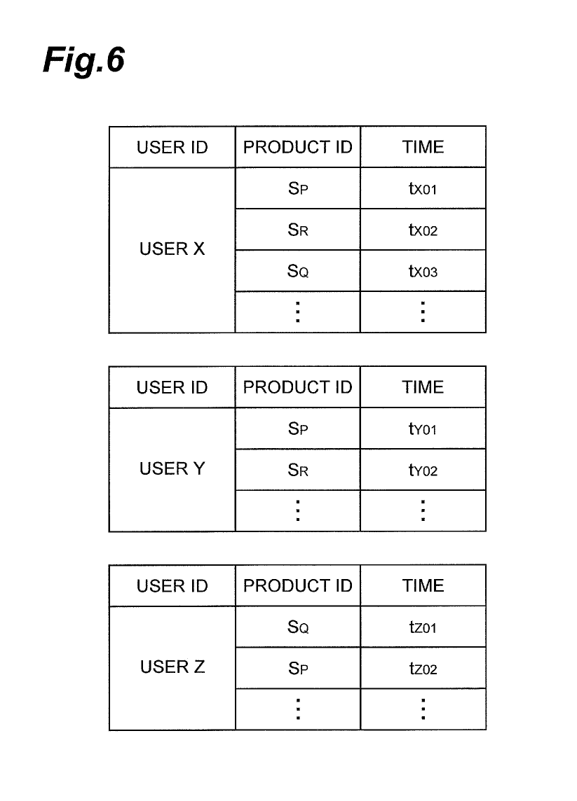

The purchase history storage unit 29 is a data base that stores the purchase record of a product purchased by the user. FIG. 6 shows an example of the configuration of the purchase history storage unit 29 and stored data. As FIG. 6 shows, the purchase history storage unit 29 stores at least the product ID of the purchased product for each user ID for identifying the user. The purchase history storage unit 29 may also store the time when the product is purchased.

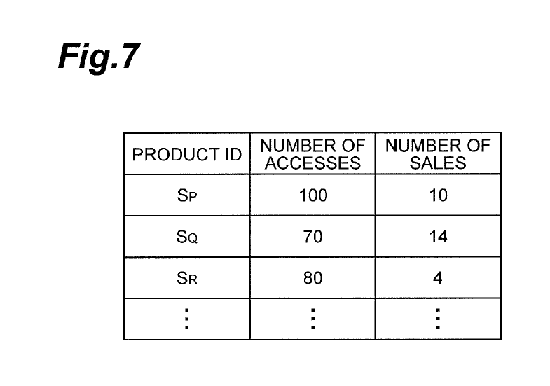

The history information processing unit 28 refers to the access history storage unit 13, tabulates the number of times when the user accessed the product page for each product ID, and acquires the tabulated count as the number of accesses in the access state storage unit 14. The history information processing unit 28 also refers to the purchase history storage unit 29, tabulates the number of purchased products for each product ID, and acquires the tabulated number as the number of sales in the access state storage unit 14. Then the history information processing unit 28 stores the acquired number of accesses and number of sales in the access state storage unit 14. FIG. 7 shows an example of a configuration of the access state storage unit 14 and stored data. As FIG. 7 shows, the access state storage unit 14 stores the number of accesses and the number of sales in correspondence with the product ID.

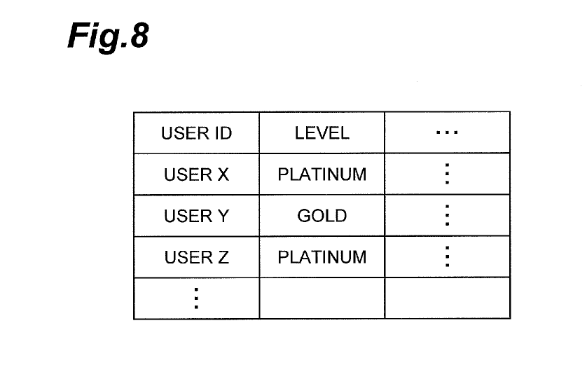

The user information storage unit 15 is a portion that stores the attribute information of the user. FIG. 8 shows an example of a configuration of the user information storage unit 15 and stored data. As FIG. 8 shows, the user information storage unit 15 stores the level of attribute information in correspondence with the user ID for identifying the user. The level is, for example, an attribute that is set according to the purchase amount of the product by the user, and in this embodiment, the level is set to one of platinum, gold and silver, in order of ascending purchase amount.

The determination unit 16 is a portion that determines a product page on which a specific object is displayed based on the access state from the user terminals U to the product type. Variations of processing to determine the product page will now be described in detail.

The determination unit 16 can acquire the number of accesses to each product page, which the user terminals U accessed in a predetermined time period as the access state, and determine displaying a specific object on a product page of which number of accesses is a predetermined number or more. In concrete terms, the determination unit 16 refers to the access state storage unit 14 (see FIG. 7), extracts a product ID of a product page of which number of accesses is a predetermined number or more, and determines a product page presenting this product ID as the product page on which the specific object is displayed. In this case, the object can be displayed on a product page which has high probability to be viewed by many users. Alternately, the determination unit 16 may acquire, as the access state, the number of accesses to each product page which the user terminals U accessed in a predetermined time period, and determine displaying the object on one of the product pages of which number of accesses is a predetermined number or more, such as a product page of which number of accesses is highest.

Further, the determination unit 16 may acquire, as the access state, the number of accesses to each product page which the user terminals U accessed in a predetermined time period, and determine displaying a specific object on a product page of which number of accesses is less than a predetermined number. In concrete terms, the determination unit 16 refers to the access state storage unit 14, extracts a product ID of a product page of which number of accesses is less than a predetermined number, and determines a product page presenting this product ID as the product page on which the specific object is displayed. In this case, users can be guided to view this product page by the display of the object. Alternately, the determination unit 16 may acquire, as the access state, the number of accesses to each product page which the user terminals U accessed in a predetermined time period, and determine displaying the specific object on one of the product pages of which number of accesses is less than a predetermined number.

Further, the determination unit 16 may acquire the number of user terminals U who have viewed each product page by now as the access state, and determine displaying a specific object on a product page of which the number of user terminals U is a predetermined number or more. In concrete terms, the determination unit 16 tabulates the number of user terminals U which have viewed each product page by now, with reference to the access history storage unit 13, and determines a product page of which the tabulated number of user terminals U is a predetermined number or more as the product page on which a specific object is displayed. In this case, the object can be presented to many users. Alternately, the determination unit 16 may acquire the number of user terminals U which have viewed each product page by now as the access state, and determine displaying a specific object on one of the product pages of which number of user terminals is a predetermined number or more, such as a product page to which the highest number of user terminals have accessed. For the number of user terminals which have accessed the product page, the number of users who have accessed the product page via user terminals may be used.

Further, the determination unit 16 may acquire the number of user terminals U who have viewed each product page by now as the access state, and determines displaying a specific object on a product page of which the number of user terminals is less than a predetermined number. In concrete terms, the determination unit 16 tabulates the number of user terminals U who have viewed each product page by now, with reference to the access history storage unit 13, and determines a product page of which the tabulated number of user terminals U is less than a predetermined number as the product page on which a specific object is displayed. In this case, the number of users to whom the privilege is provided based on the presentation of the privilege information can be controlled not to be excessive. Alternately, the determination unit 16 may acquire the number of user terminals U who have viewed each product page by now as the access state, and determines displaying a specific object on one of the product pages of which the number of user terminals is less than a predetermined number.

Further, the determination unit 16 may tabulate only the user terminals of users having a predetermined attribute when the number of user terminals U who have viewed each product page by now or the number of users who have viewed the product page by now is acquired. In concrete terms, the determination unit 16 refers to the access history storage unit 13 and the user information storage unit 15 (see FIG. 8), and tabulates the number of users having “platinum” level as the predetermined attribute, out of the users of the user terminals U who have viewed the product page by now. In this case, the object can be presented to users having a specific attribute, hence it can be controlled that the privilege is provided to users having a specific attribute, such as “platinum” level with priority, for example.

Further, the determination unit 16 may determine displaying a specific object on a product page of a product of which the number of sales or a sales amount in a predetermined time period is a predetermined value or more. In concrete terms, the determination unit 16 acquires the number of sales of each product with reference to the access state storage unit 14, extracts a product ID of a product of which the acquired number of sales is a predetermined number or more, and determines the product page corresponding to the product ID as the product page on which a specific object is displayed. The determination unit 16 may determine a product page of a product, of which sales amount acquired by multiplying the number of sales by the price of the product is a predetermined value or more, as the product page on which a specific object is displayed. In this case, the object can be displayed on a page which has high probability that the product is purchased by many users.

Further, the determination unit 16 may determine displaying a specific object on a product page of a product of which the number of sales or sales amount in a predetermined time period is less than a predetermined value. In concrete terms, the determination unit 16 acquires the number of sales of each product with reference to the access state storage unit 14, extracts a product ID of a product of which the acquired number of sales is less than a predetermined number, and determines the product page corresponding to the product ID as the product page on which a specific object is displayed. The determination unit 16 may determine a product page of a product of which sales amount acquired by multiplying the number of sales by the price of the product is less than a predetermined value as the product page on which a specific object is displayed. In this case, users can be guided to purchase a product by the display of the object when sufficient sales of the product have not yet been achieved.

When a product page is determined based on the number of sales or sales amount, the determination unit 16 may determine a product page based not on the number of sales or a sales amount of a product, but on a ratio of the number of sales or the sales amount to the number of accesses from the user terminal to the product page in a predetermined time period. In concrete terms, the determination unit 16 acquires the number of accesses and the number of sales of each product with reference to the access state storage unit 14, calculates a ratio of the number of sales to the number of accesses, and determines the product page of the product of which the calculated ratio is a predetermined value or more, or less than the predetermined value, as a product page on which a specific object is displayed. If a product page of a product page of which calculated ratio is a predetermined value or more is determined as a product on which an object is displayed, the object can be displayed on a product page which has high probability that the product will be purchased. If a product page of a product of which calculated ratio is less than a predetermined value is determined as a product page on which an object is displayed, the ratio of the number of users who purchase the object with respect to the users who access the product page can be improved by the display of the object.

Further, the determination unit 16 may determine a product page on which a specific object is displayed, according to an expected value of points granted to users by the privilege, based on the access state and the content of the privilege. In concrete terms, the determination unit 16 determines a product page, of which expected value of points granted to the users by the privilege is a first predetermined value (preset in advance) or less and an error from the first predetermined value is a second predetermined value or less, as a product page on which a specific object is displayed.

Here the expected value of points granted to the users by the privilege is, for example, a total number of points which are expected to be granted to the users when the privilege is provided to the users based on the access state. If the content of the privilege is to grant 100 points to the user, for example, and if the number of viewers of a product page is 100, then an expected value of points to the users when an object is displayed on the product page is 10,000 points (points granted to user×the number of viewers). As an expected value, the determination unit 16 may calculate the number of points by further multiplying a ratio of the number of users who purchased the product with respect to the number of viewers. The ratio of the number of users who purchased the product with respect to the number of viewers can be acquired based on the sales record (not illustrated) of the product in the past, for example.

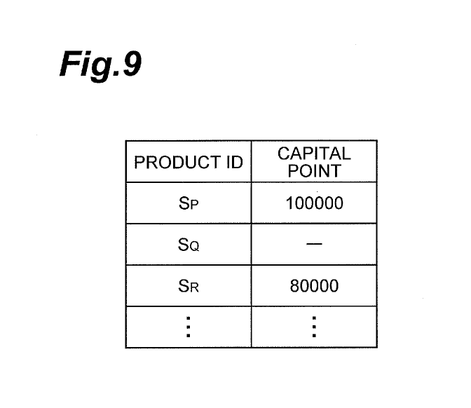

The predetermined value with which the expected value of the points is compared is, for example, a total of points which is set in advance as points to be granted to users by the privilege. In the following description, this number of points is referred to as “capital points”. The capital points may be set for each product, for example, or may be set for each store which sells a plurality of products, or may be set in every predetermined period (e.g. every day). FIG. 9 shows an example of a configuration of the capital point information storage unit 27 and stored data. In the example shown in FIG. 9, capital points are stored for each product ID to identify the product. The capital point information storage unit 27 may store the capital points for each store or may store a total number of points granted to users as privileges in a predetermined period as the capital points.

In concrete terms, the determination unit 16, for example, refers to the access history storage unit 13, and calculates an expected value by multiplying the acquired number of user terminals U which have viewed each product page by now by the number of points granted to one user as a privilege, and determine, as a product page on which a specific object is displayed, a product page of a product of which calculated expected value matches the number of capital points of the product stored in the capital point information storage unit 27, or the number of capital points or less, and the difference from the number of capital points is less than a predetermined value.

The determination unit 16 can select a product page using at least one of the above mentioned methods. If a plurality of product pages are extracted by an above method, as the product page on which a specific object is displayed, the determination unit 16 may determine displaying the object on all the extracted pages, or may determine displaying the object on at least one product page out of the extracted product pages based on other parameters, or at random.

The description on functional units will now continue with reference to FIG. 2. The control unit 17 is a portion that performs display control to display an object on a product page determined by the determination unit 16. Further, the control unit 17 performs non-display control which does not display an object at a predetermined timing.

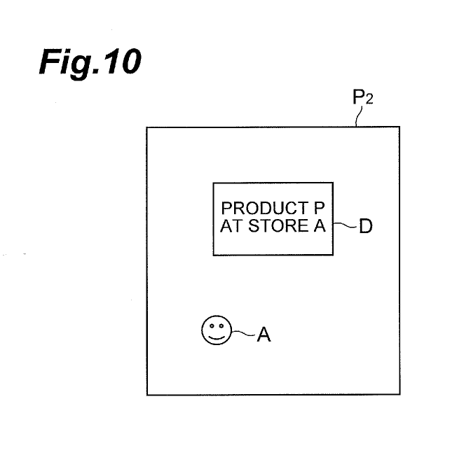

The control unit 17 can perform the display control and the non-display control using various methods. For example, as the display control, the control unit 17 generates a product page including an object based on the product page determined by the determination unit 16. In concrete terms, the control unit 17 acquires the product page determined by the determination unit 16 from the product page storage unit 12, generates a product page by superposing an object on the acquired product page, and stores the generated product page in the product page storage unit 12 as the product page of this product. FIG. 10 is a diagram depicting an example of the product page generated by the control unit 17. The product page P₂ shown in FIG. 10 is the product page shown in FIG. 4(b) on which an object is displayed. As FIG. 10 shows, the product page P₂ includes display of the object A, in addition to the information D for presenting the product.

As the non-display control, the control unit 17 deletes the object from a product page, including the object at the predetermined timing. In concrete terms, the control unit 17 acquires a product page, which is determined by the determination unit 16 and on which an object is superposed by the display control, from the product page storage unit 12, deletes the object from the acquired product page, and stores the product page, of which the object is deleted, in the product page storage unit 12 again. As a result, if a user terminal U requests the product page to the electronic commerce apparatus 1 after the control unit 17 performed the display control and before the control unit 17 performs the non-display control, the product page including the object is displayed on the user terminal U. Alternatively, when an object is superposed by the display control on the product page determined by the determination unit 16, the control unit 17 may delete the object from the product page by including a program to delete the object at a predetermined timing from the product page as the non-display control.

Further, the display control and the non-display control may be performed on the product page stored in the product page storage unit 12 by including predetermined control information in advance. The control information included in the product page allows controlling the display or non-display of the object on the product page based on the inquiry to the electronic commerce apparatus 1 and instruction information from the electronic commerce apparatus 1. This control information can be implemented by such a technology as Ajax. If a product page including the control information is displayed on the user terminal U, the control information inquires of the control unit 17 of the electronic commerce apparatus 1 whether or not the object is displayed on the product page periodically at a predetermined time interval. In response to the inquiry by the control information included in the product page from the user terminal U displaying the product page determined by the determination unit 16, the control unit 17 transmits the instruction information to display the object (e.g. update instruction information of flag parameters in the control information whether or not the object is displayed) to the user terminal U. As the non-display control, the control unit 17 transmits the instruction information not to display the object to the user terminal, in response to the inquiry using the control information included in the product page from the user terminal U displaying the product page including the object, at a predetermined timing. Since the display or non-display of the object is controlled by transmitting the instruction information to the user terminal U in response to the inquiry using the control information included in the product page, display of the object on the product page can be controlled with high accuracy.

The display control and the non-display control may be performed by transmitting the instruction information to display or not to display the object from the electronic commerce apparatus 1 to the user terminal U by the so called “push type transmission”. In this case, predetermined control information may be included in advance on the product page to be stored in the product page storage unit 12, so that this control information can be used to control the display or the non-display of the object on this product page based on the instruction information from the electronic commerce apparatus 1. In concrete terms, as the display control, the control unit 17 transmits the instruction information to display the object on this product page to the user terminal U displaying the product page determined by the determination unit 16. The instruction information in this case is, for example, update instruction information for data in the control information (e.g. messages, flags, parameters) to control whether or not the object is displayed. Alternatively, as the display control, the control unit 17 may transmit an application to display the object on the product page as the instruction information, to the user terminal U displaying the product page determined by the determination unit 16. The control unit 17 can recognize the user terminal U currently displaying a specific product page by referring to the access history storage unit 13. As the non-display control, the control unit 17 transmits the instruction information not to display the object to the user terminal U, displaying the product page including the object, at a predetermined timing. The instruction information in this case is, for example, update instruction information for data in the control information (e.g. messages, flags, parameters) to control whether or not the object is displayed. Alternatively, as the non-display control, the control unit 17 may transmit an application to delete the object from the product page as the instruction information, to the user terminal U displaying the product page including the object, at a predetermined timing. The transmission of the application from the electronic commerce apparatus 1 to the user terminal U can be implemented by such a technology as a Web socket, for example.

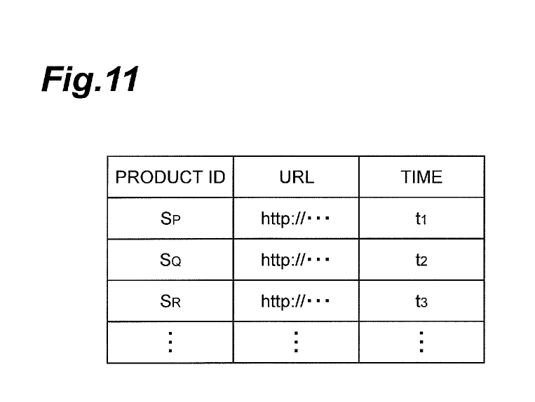

If the display control to display the object on the product page is performed, the control unit 17 may store the record in the object display record storage unit 18. FIG. 11 shows an example of a configuration of the object display record storage unit 18 and stored data. As FIG. 11 shows, the object display record storage unit 18 stores the product ID, the URL of the product page and the time when the object was displayed as the record of the product page on which the object is displayed.

Now variations of the predetermined timing when the control unit 17 performs the non-display control will be described in detail. The control unit 17 performs the non-display control when a predetermined time has elapsed since the display control was performed, for example. In concrete terms, the control unit 17 refers to the object display record storage unit 18, acquires the time when the display control of the object was performed on the product page, and performs the non-display control of the object on the product page when a predetermined time (set in advance) elapses from the acquired time. In this case, the time period when the object is displayed can be controlled to be a predetermined time.

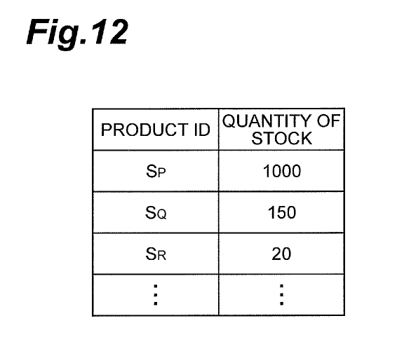

The control unit 17 acquires the number of accesses from the user terminals U to the product page on which the object is displayed since the display control is performed, and performs the non-display control when the number of accesses reaches a predetermined number or more. In concrete terms, the control unit 17 refers to the access history storage unit 13 or the access state storage unit 14, acquires the number of accesses from the user terminals U to the product page on which the object is displayed after the display control is performed, and performs the non-display control for this product page when the number of accesses reaches a predetermined number or more. In this case, the number of users who viewed the product page including the object can be limited to a predetermined number, so a total number of users to whom the privilege is provided can be controlled with a predetermined or higher level of accuracy. The predetermined value of the number of accesses used for determination to perform the non-display control may be set considering a quantity of stock of the product of the product page, for example. FIG. 12 shows an example of a configuration of a product stock storage unit 19 and stored data. As FIG. 12 shows, the product stock storage unit 19 stores a quantity of stock of this product in correspondence with the product ID for identifying the product. In concrete terms, the control unit 17 refers to the product stock storage unit 19 storing a quantity of stock, acquires a quantity of stock of the product presented by the product page, and sets the acquired quantity of stock to a predetermined value for determining the number of accesses to perform the non-display control.

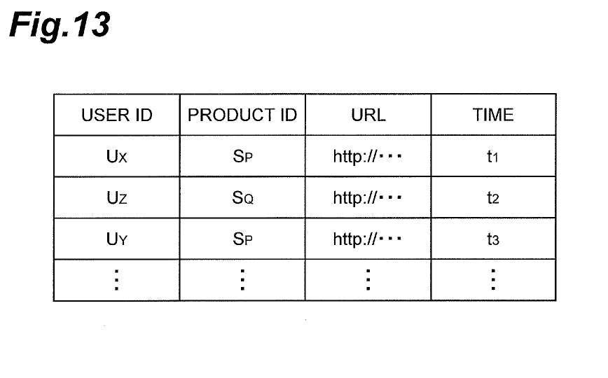

Further, the control unit 17 performs the non-display control when the number of pieces of operation information transmitted from a plurality of user terminals U and received by the transmission unit 20 reaches a predetermined number or more. The operation information is information indicating that a user has operated an object on a product page displayed on each of the plurality of user terminals U. Reception of the operation information by the transmission unit 20 will be described later. FIG. 13 shows an example of a configuration of the object operation information storage unit 21 that stores operation information received by the transmission unit 20, and stored data. As FIG. 13 shows, the operation information includes a user ID, product ID, URL and time, of the user terminal at the transmission source of the operation information. The product ID and URL of the operation information is the ID of the product presented on the product page and the URL of the product page. The time of the operation information indicates the time when the object was operated from the user terminal U. In concrete terms, the control unit 17 refers to the object operation information storage unit 21, and tabulates, for each product page (for each product), the operation information sent from the user terminals U where the product page including the object is displayed, and performs the non-display control on this product page when the tabulated number of pieces of operation information reaches a predetermined number or more. Since the number of users to whom the privilege information is presented can be limited to a predetermined number, a total number of points to be granted to users based on the privilege provision can be controlled with at least a predetermined accuracy.

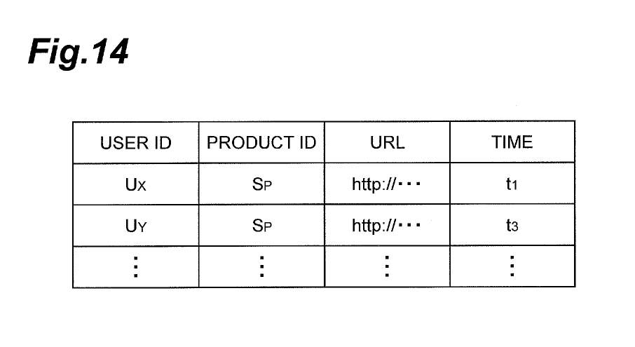

The control unit 17 may perform the non-display control when the number of users to whom the privilege is granted according to the presentation of the privilege information by the transmission unit 20 reaches a predetermined number or more. The privilege granted to the user is provided based on the privilege request transmitted from the user terminal U to the electronic commerce apparatus 1 by performing a predetermined operation on the privilege presenting page for presenting the privilege information, that is displayed on the user terminal U. The privilege request transmitted from the user terminal U is received by the privilege request receiving unit 23 of the electronic commerce apparatus 1. The privilege request receiving unit 23 stores the received privilege request record in the privilege acquired user storage unit 24. FIG. 14 shows an example of a configuration of the privilege acquired user storage unit 24 for storing the privilege requests and stored data. As FIG. 14 shows, the privilege acquired user storage unit 24 stores the product ID and URL of the product page on which the object to grant the privilege is displayed, and the time when the privilege request was received, in correspondence with the user ID of the user terminal U which transmitted the privilege request. The control unit 17 refers to the privilege acquired user storage unit 24, and calculates the number of users who received the privilege by tabulating the number of privilege requests for each product page (product ID or URL) on which the object is displayed, and performs the non-display control on this product page when the calculated number of users reaches a predetermined number or more. Since the number of users to whom the privilege is granted can be limited to a predetermined number, a total number of points to be granted to users based on the privilege provision can be controlled with high accuracy.

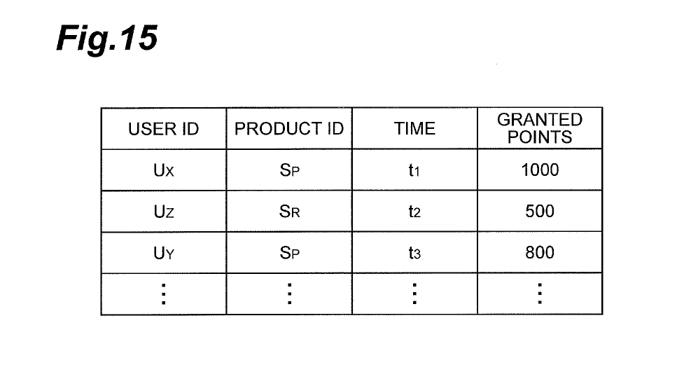

The control unit 17 may perform the non-display control when points are granted to users as privilege, and a total number of points granted to users as privilege reaches a predetermined value which is set in advance. The points granted to users as privilege are managed by the privilege request receiving unit 23. In concrete terms, the privilege request receiving unit 23 stores the points granted to the user as privilege in the granted point storage unit 25. FIG. 15 shows an example of a configuration of the granted point storage unit 25 and storage data. As FIG. 15 shows, the granted point storage unit 25 stores the product ID of the product page on which the object to grant the privilege is displayed, the time when the privilege is granted, and the granted points in correspondence with the user ID of the user to whom points are granted as the privilege. Granting points as privilege includes not only cases of granting a predetermined number of points, but also cases of granting points by multiplying the points granted by ordinary purchase of a product by a predetermined number. Therefore the granted points stored in the granted point storage unit 25 include both of these cases. In concrete terms, the control unit 17 refers to the granted point storage unit 25, calculates a total points granted to each user for each product page (product ID) on which the object is displayed, and performs the non-display control of the object on the product page when the total of the calculated points reaches a predetermined value. For the predetermined value of the points used for the determination, a value based on the capital points acquired from the capital point information storage unit 27 can be used. Thereby the total number of points granted to users based on the privilege provision can be controlled accurately. The points granted by a privilege and points granted by the ordinary purchase of the product may be managed separately. In this case, the control unit 17 refers to the granted point storage unit 25, calculates the total points granted to each user based on the privilege provision, for each product page (product ID) on which the object is displayed, and performs the non-display control of the object on the product page when the calculated total of these points reaches a predetermined value.

The control unit 17 performs the non-display control of an object on one product page, and then performs the display control to display the object on another product page that is determined by the determination unit 16 and is different from that one product page. Thereby if an object is no longer displayed at a predetermined timing after the object is displayed on that one product page, an object is displayed on another product page. By performing the display control and the non-display control like this, a user who desires provision of a privilege can be encouraged to browse a plurality of product pages on a site searching for product pages on which objects are displayed.

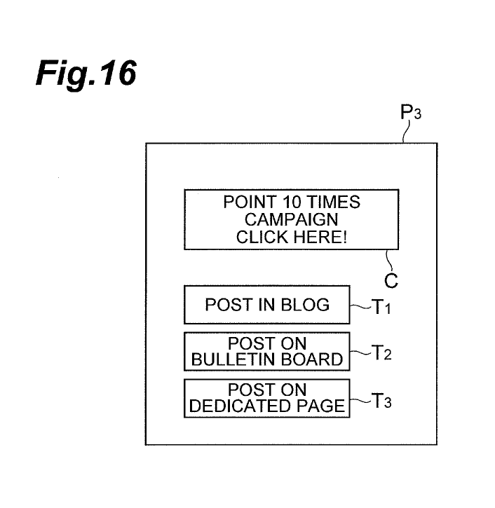

Now description of the functional units will be continued with reference to FIG. 2. The transmission unit 20 is a portion to transmit a privilege presenting page, to present privilege information on a privilege provided to the users, to the user terminal U if operation information, to indicate that the user has operated an object displayed on a product page which is displayed on the user terminal U, is received. For example, if the user has operated on an object A on a product page displayed on a user terminal U, as shown in FIG. 10, the operation information is transmitted from the user terminal U to the transmission unit 20 of the electronic commerce apparatus 1. If the operation information is received, the transmission unit 20 transmits the privilege presenting page to the user terminal U which transmitted the operation information. The privilege presenting page is displayed on the user terminal U for the user. FIG. 16 is a diagram depicting an example of the privilege presenting page. As FIG. 16 shows, the privilege presenting page P₃ includes display of the privilege information C. If the display portion of the privilege information C is operated on the privilege presenting page P₃ displayed on the user terminal U, a privilege request is transmitted from the user terminal U to the electronic commerce apparatus 1.

If the privilege request is transmitted from the user terminal U to the electronic commerce apparatus 1, a predetermined privilege is granted to the user of the user terminal U. The content of the privilege is, for example, granting a predetermined number of points by a purchase during a predetermined period, granting a predetermined number of points for participation request during a predetermined period, discount service during a predetermined period, or granting a coupon that can be used during a predetermined period. The content of the privilege may also be granting the user a status of granted points that is multiplied by a predetermined number if the user purchased a product during a predetermined period after the display portion of the privilege information C is operated, or if the user purchased a product in the same store where the user had purchased another product, or if the user purchased a product in a system 100 including the electronic commerce apparatus according to this embodiment. In this case, the predetermined period when the status is maintained may be a period when the object is being displayed on the product page by which the privilege was granted, or may be a predetermined period which is set in advance.

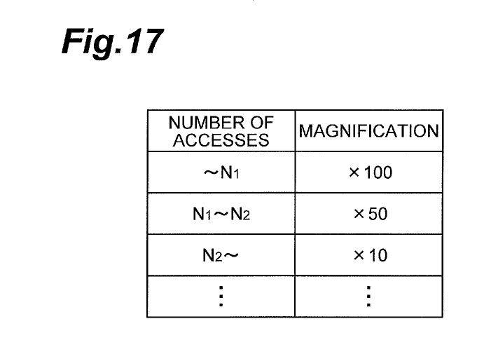

Furthermore, the transmission unit 20 may determine the content of the privilege provided to the user according to the access state of the product page. For example, the transmission unit 20 can determine the content of the privilege with reference to the privilege magnification setting table 22. FIG. 17 shows an example of a configuration of a privilege magnification setting table 22 and stored data. As FIG. 17 shows, the privilege magnification setting table 22 stores a predetermined range that is set for the number of accesses in correspondence with a magnification used to multiply the points. The transmission unit 20 refers to the access state storage unit 14, acquires the number of accesses of the product page on which the object is displayed, acquires a magnification in correspondence with the acquired number of accesses from the privilege magnification setting table 22, and sets the acquired magnification as the content of the privilege to be provided to the user. For example, if a higher magnification is set as a privilege for a product page of which number of accesses is low, and this information is notified on a later mentioned information providing page, then many users can be guided to the product page of which number of accesses is low.

Now description of the privilege presenting page P₃ will be continued with reference to FIG. 16. The privilege presenting page P₃ can include the operation units T₁ to T₃ for transmitting post information that instructs to display the information on the product page on which the object is displayed on a page which general user terminals U can view. In other words, if the operation units T₁ to T₃ are operated on the user terminal U on which the privilege presenting page P₃ is presented, the post information is transmitted from this user terminal to a predetermined transmission destination. For example, if the operation unit T₁ is operated on the user terminal U, the post information, including information to notify that an object A is displayed on the product page P₂ of the product P, is posted on a predetermined blog. If the operation unit T₂ is operated on the user terminal U, the post information with a same content is posted on a predetermined bulletin board or social network service. If the operation unit T₃ is operated on the user terminal U, the post information with the same content is transmitted to the privilege information management unit 26 of the electronic commerce apparatus 1, and is displayed on a predetermined dedicated page. In other words, the transmission destination to which the post information is transmitted is at least one of the electronic commerce apparatus 1, a predetermined social network service, and a web site that provides a web page for opening the received information to general users on the Internet. Since information on a product page on which the object is displayed is notified to the general users like this, the users who received the information can be guided to the site managed by the electronic commerce apparatus 1.

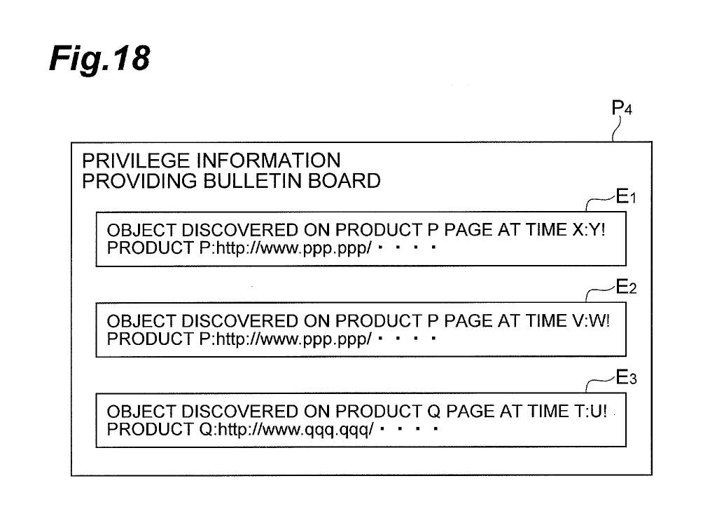

Referring back to FIG. 2, the privilege information management unit 26 is a portion that receives the post information, generates an information providing page including the information on the product page on which the object is displayed, and replies with the information providing page in response to a request from the general user terminal. FIG. 18 is a diagram depicting an example of the information providing page. As FIG. 18 shows, the information providing page P₄ is generated in the format of a so called “bulletin board”, and includes information E₁ to E₃ to notify that the object is displayed one of the product pages. The information Eₗ to E₃ can include information on the product page on which the object is displayed, time when the object was displayed on the product page, and URL information of the product page. The privilege information management unit 26 replies with the information providing page P₄ like this in response to a request from a general user terminal. Since information on the product page on which the object is displayed is integrated to the dedicated information providing page provided by the electronic commerce apparatus 1, and is provided to general users, the users can easily acquire information on the product page on which an object is displayed, and users who received the information can be guided to the site managed by the electronic commerce apparatus 1 of the present embodiment.

The information providing page provided by the electronic commerce apparatus 1 may include not only the information on the product page on which an object is displayed, but also information on the number of points each user acquired by provision of the privilege, information to indicate the product on the product page on which an object is displayed in the future, information that recommends this product, and information to notify the content of the privilege, for example. By providing this information to general users, many users can be guided to a site managed by the electronic commerce apparatus 1 of this embodiment. Posting the information on the product page, on which an object is displayed to a dedicated page or the like, may be performed after the object is no longer displayed on the product page. Then the willingness to search for the next product page on which an object is displayed can be improved, while preventing an excessive concentration of accesses to a product page on which an object is displayed.

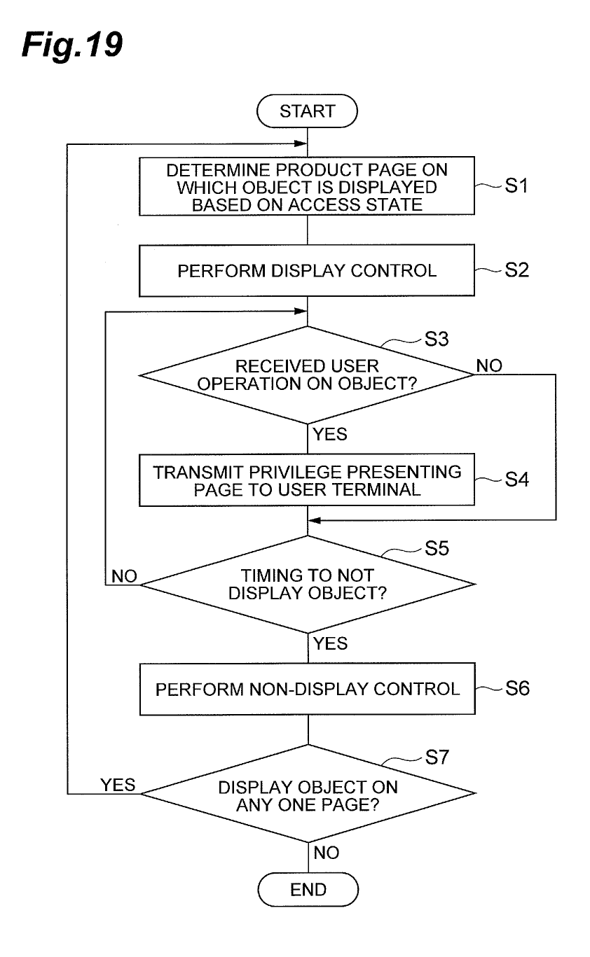

Now operation of the electronic commerce apparatus 1 of this embodiment will be described with reference to FIG. 19. FIG. 19 is a flow chart depicting the processing content of the privilege control method performed in the electronic commerce apparatus 1.

First the determination unit 16 determines a product page on which a predetermined object is displayed based on the access state from the user terminals U to the product page (S1). Then the control unit 17 performs the display control displaying the object on the product page determined by the determination unit 16 (S2).

Then the transmission unit 20 determines whether or not the operation information, to indicate that the user has operated the object displayed on the product page displayed on the user terminal U, was received (S3). If it is determined that the operation information was received, the processing procedure advances to step S4. If it is determined that the operation information was not received, on the other hand, the processing procedure advances to step S5.

In step S4, the transmission unit 20 transmits the privilege presenting page to present the privilege information to the user terminal U which transmitted the operation information (S4).

In step S5, the control unit 17 determines whether a predetermined timing to perform the non-display control has come (S5). If it is determined that the predetermined timing has come, the processing procedure advances to step S6. If it is determined that the predetermined timing has not come, the processing procedure returns to step S3.

In step S6, the control unit 17 performs the non-display control to not display the object. If the control unit 17 displays the object again thereafter (S7), processing returns to step S1.

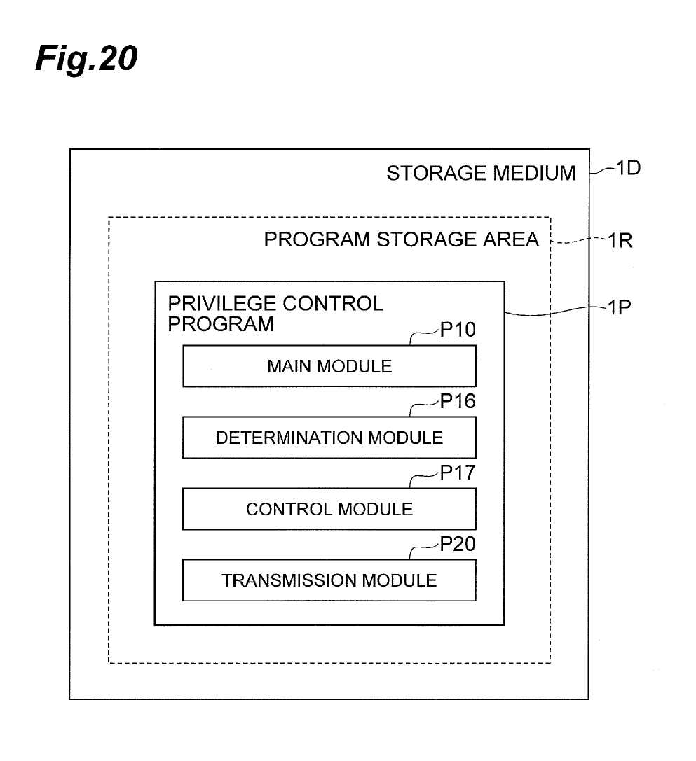

Now the privilege control program for causing the computer to function as the electronic commerce apparatus 1 will be described with reference to FIG. 20. FIG. 20 is a diagram depicting a configuration of the privilege control program 1P.

The privilege control program 1P includes a main module P10, a determination module P16, a control module P17 and a transmission module P20.

The main module P10 is a portion which comprehensively controls the electronic commerce apparatus 1. The functions implemented by executing the main module P10, the determination module P16, the control module P17, and the transmission module P20 are the same as the functions of the determination unit 16, the control unit 17 and the transmission unit 20 of the electronic commerce apparatus 1 shown in FIG. 2 respectively.

The privilege control program 1P is provided, for example, by a storage medium 1D or a semiconductor memory, such as CD-ROM, DVD and ROM. The privilege control program 1P may be provided as computer data signals superposed on carrier waves via a communication network.

According to the electronic commerce apparatus 1 and the privilege control method of this embodiment described above, a product page on which an object to receive the privilege is displayed is determined based on the access state, and the control to display or not display the object on the product page is performed, therefore the access state is reflected on determining the product page to be the subject of granting the privilege. As a result, granting the privilege can function as an incentive to purchase the product according to the access state. Further, the object is displayed or not displayed on the product page according to the access state, hence users who desire provision of privilege can search for product pages on which the object is displayed. As a consequence, provision of privilege can motivate users to browse the site. Normally on an electronic commerce site, there is a demand to make many users browse the site by keeping them on the site and have them view product pages of various products. However, in the case of a conventional electronic commerce site, products for which privilege is granted are set in advance, so the setting of privilege can motivate users to view the products, but does not motive users to browse the site.

Further, in the case of the electronic commerce apparatus 1 according to this embodiment, the control to display or not display an object on a product page is performed according to the access state, hence users who desire provision of privilege can search for product pages on which the object is displayed. As a consequence, provision of privilege can motive users to browse the site.

The present invention has been described based on the embodiments. However, the present invention is not limited to the embodiments. Numerous modifications can be made for the invention without departing from the true spirit and scope of the invention.

For example, when an object is currently being displayed on a product page and the determination unit 16 determines a product page on which the object is to be displayed next, the control unit 17 may perform control to display information to recommend the product of the product page on which the object is to be displayed next, on the product page on which the object is currently displayed. The information to recommend the product is, for example, information on the category which this product belongs to.

When the non-display control is performed for an object on a product page, the control unit 17 may perform a control to display information or to display an object on the product page to notify that the object has been displayed up until that moment.

If the operation information to indicate that the object is operated is received, the transmission unit 20 may transmit an information page to present information on the sale which is scheduled on the site managed by the electronic commerce apparatus 1 to the user terminal U, instead of the privilege presenting page.

The product page for presenting a sales target product to the user terminal is corresponded with each product, and a plurality of products may be included on one page, for example.

### INDUSTRIAL APPLICABILITY

As described above, according to this embodiment, an electronic commerce apparatus that allows a privilege granted to users by purchase of a product on an electronic commerce site to function as an incentive according to the access state that changes in real time.

### REFERENCE SIGNS LIST

1 electronic commerce apparatus
11 product page transmission unit
12 product page storage unit
13 access history storage unit
14 access state storage unit
15 user information storage unit
16 determination unit
17 control unit
18 object display record storage unit
19 product stock storage unit
20 transmission unit
21 object operation information storage unit
22 privilege magnification setting table
23 privilege request receiving unit
24 privilege acquired user storage unit
25 granted point storage unit
26 privilege information management unit
27 capital point information storage unit
28 history information processing unit
29 purchase history storage unit
1P privilege control program
P10 main module
P16 determination module
P17 control module
P20 transmission module
T₁ to T₃ operation units

1. An electronic commerce apparatus that has product pages to present sales target products to user terminals in correspondence with respective products, and transmits the product pages to a user terminal in response to a request from the user terminal, comprising:
a determination unit configured to refer to an access state storage unit that stores an access state information from user terminals to product pages, and determine a product page to display a specific object based on the access state information;
a control unit configured to perform display control to display the object on the product page determined by the determination unit, and a non-display control to not display the object, at a predetermined timing, on the product page on which the object has been displayed; and
a transmission unit configured to transmit, to the user terminal, a privilege presentation page for presenting privilege information on a privilege provided to the user upon receiving operation information indicating that the user has operated the object displayed on the product page that is displayed on the user terminal.

2. The electronic commerce apparatus according to claim 1, wherein
the control unit performs non-display control for the object on one product page first, and then performs the display control to display the object on a product page that is determined by the determination unit and is different from that one product page.

3. The electronic commerce apparatus according to claim 1, wherein
the privilege presentation page includes an operation unit for transmitting post information that instructs to display information on a product page on which an object is displayed, on a page viewable from general user terminals, and
if the operation unit is operated in the user terminal where the privilege presentation page is presented, the post information is transmitted from the user terminal to a predetermined transmission destination.

4. The electronic commerce apparatus according to claim 3, wherein
the predetermined transmission destination is at least one of the electronic commerce apparatus, a predetermined social network service, and a web site that provides a web page to open the received information to general users on the Internet.

5. The electronic commerce apparatus according to claim 3, further comprising:
a privilege information management unit configured to receive the post information, generate or update an information providing page which includes information on a product page on which an object is displayed, and reply with the information providing page in response to a request from a general user terminal.

6.-10. (canceled)

11. The electronic commerce apparatus according to claim 1, wherein
points are granted to a user by purchase of a product via electronic commerce provided by the electronic commerce apparatus, and the privilege provided to the user for whom the privilege information is presented is granting of more points than points granted by ordinary purchase of a product, and
the determination unit determines, according to the access state and the content of the privilege, a product page on which the specific object is displayed based on an expected value of the points granted to the user by the privilege.

12. The electronic commerce apparatus according to claim 11, wherein
the determination unit determines, a product page on which the specific object is displayed, and where an expected value of points granted to the user by the privilege is not more than a first predetermined value which is set in advance, and an error of the expected value from the first predetermined value is a second predetermined value or less.

13. The electronic commerce apparatus according to claim 1, wherein
the control unit performs the non-display control when a predetermined time elapses after performing the display control.

14. The electronic commerce apparatus according to claim 1, wherein
the control unit acquires the number of accesses from user terminals to the product page on which the object is displayed since the start of the display control, and performs the non-display control when the number of accesses reaches a predetermined number or more.

15. The electronic commerce apparatus according to claim 1, wherein
the control unit performs the non-display control when the number of pieces of the operation information received by the transmission unit reaches a predetermined number of more.

16. The electronic commerce apparatus according to claim 1, wherein
the control unit performs the non-display control when the number of users to whom privilege is provided according to the presentation of the privilege information by the transmission unit reaches a predetermined number or more.

17. The electronic commerce apparatus according claim 1, wherein
points are granted to a user by purchase of a product via electronic commerce provided by the electronic commerce apparatus, and the privilege provided to the user for whom the privilege information is presented is granting of more points than points granted by ordinary purchase of a product, and
the control unit performs the non-display control when the total points granted to the user by the privilege reaches a predetermined value which is set in advance.

18. The electronic commerce apparatus according to claim 1, wherein
the control unit generates, as the display control, a product page including the object based on the product page determined by the determination unit, and
generates, as the non-display control, a product page by deleting the object from the product page including the object at a predetermined timing.

19. The electronic commerce apparatus according to claim 1, wherein
the product page includes control information for inquiring to the electronic commerce apparatus and controlling to display or not display the object on the product page based on instruction information from the electronic commerce apparatus, and
as the display control, the control means unit generates instruction information to display the object in response to an inquiry from a user terminal which is displaying the product page determined by the determination means unit, the inquiry being made using the control information included in the product page, and transmits the instruction information to the user terminal, and
as the non-display control, the control unit transmits instruction information not to display the object to the user terminal at the predetermined timing, in response to the inquiry from the user terminal which is displaying the product page including the object, the inquiry being made using the control information included in the product page.

20. The electronic commerce apparatus according to claim 1, wherein
as the display control, the control unit transmits instruction information to a user terminal which is displaying the product page determined by the determination unit, to instruct the user terminal to display the object on the product page, and
as the non-display control, the control unit transmits instruction information at the predetermined timing to the user terminal which is displaying the product page including the object, to instruct the user terminal not to display the object.

21. A privilege control method used for an electronic commerce apparatus that has product pages to present sales target products to user terminals in correspondence with respective products, and transmits the product pages to a user terminal in response to a request from the user terminal, comprising:
a determination step of referring to an access state storage unit that stores an access state from user terminals to product pages, and determining a product page to display a specific object based on the access state;
a display control step of displaying the object on the product page determined in the determination step;
a transmission step of transmitting, to the user terminal, a privilege presentation page for presenting privilege information on a privilege provided to the user upon receiving an operation by the user performed on the object displayed on the product page that is displayed on the user terminal; and
a non-display control step of performing non-display control to not display the object, at a predetermined timing, on the product page on which the object has been displayed.

22. (canceled)

23. A computer readable storage medium storing a privilege control program for causing a computer to function as an electronic commerce apparatus that has product pages to present sales target products to user terminals in correspondence with respective products, and transmits the product pages to a user terminal in response to a request from the user terminal,
wherein a commerce management program causes the computer to execute:
a determination function for referring to an access state storage means unit that stores an access state from user terminals to product pages, and determining a product page to display a specific object based on the access state;
a control function to enable display control to display the object on the product page determined by the determination function, and non-display control to not display the object, at a predetermined timing, on the product page on which the object has been displayed; and
a transmission function for transmitting, to the user terminal, a privilege presentation page for presenting privilege information on a privilege provided to the user upon receiving an operation by the user performed on the object displayed on the product page that is displayed on the user terminal.

24. The electronic commerce apparatus according to claim 1, further comprising:
a top page transmission unit configured to transmit, to a user terminal, a top page including a plurality of links to a plurality of the product pages respectively; and
a product page transmission unit configured to, in response to a selection operation performed by the user terminal for a link included in the top page, transmit a product page corresponding to the selected link, wherein
if the product page transmitted by the product page transmission unit is a product page which has been determined by the determination unit to be a product page on which the object is displayed, the control unit performs display control to display the object on the product page displayed on the user terminal.

25. The electronic commerce apparatus according to claim 1, wherein
the control unit performs control to display information indicating that the object has been displayed, on the product page on which the non-display control is performed.
